(19) United States
(12) Patent Application Publication
(10) Pub. No.: US 2012/0279054 A1
(43) Pub. Date: Nov. 8, 2012

(54) Method of Configuring Cathodes of an Aluminum Reduction Cell

(75) Inventors: Cairong Chen, Guiyang (CN); Yi Yang, Guiyang (CN)

(73) Assignee: CHINA ALUMINUM INTERNATIONAL ENGINEERING CORPORATION LIMITED, Beijing (CN)

(21) Appl. No.: 13/519,942

(22) PCT Filed: Dec. 31, 2010
(86) PCT No.: PCT/CN10/02237

§ 371 Date: Jul. 30, 2012

(30) Foreign Application Priority Data
Dec. 31, 2009 (CN) 200910312839.8

(51) Int. Cl. H01M 6/00

(52) U.S. Cl. 29/623.1

(57) ABSTRACT

The present invention discloses a method of configuring energy saving high and low cathodes of an aluminum reduction cell, said method comprising disposing cathode carbon blocks and cathode steel rods at the bottom of the aluminum reduction cell, the cathode carbon blocks being formed by staggering high cathode blocks and low cathode blocks with different thicknesses. Both sides of the portion of each of the high cathode blocks higher than each of the low cathode blocks must be machined into bevels or arc angles, so as to achieve a good choking effect. The present invention can better improve the stability of molten aluminum-electrolyte interface within the aluminum reduction cell, decrease the polar distance effectively during normal production, and achieve a lower operating voltage of the reduction cell, thereby saving energy and reducing energy consumption.

### TECHNICAL FIELD

The present invention relates to a method of configuring cathodes of an aluminum reduction cell, and more particularly to a method of configuring high and low cathodes, pertaining to the technical art of an aluminum reduction cell.

### BACKGROUND ART

With improvement of design and operating technical level of the aluminum reduction cell, the international and domestic newly designed and constructed aluminum reduction cells are increasingly developed to be large-scale ones. Potline current will inevitability increase to 550 kA˜700 kA, or even more. In recent years, the domestic technology of aluminum reduction has achieved great development, whereby the capacity of the reduction cell has already caught up with or even exceeded the international advanced level. However, there is relative great disparity in terms of energy saving and energy consumption reduction compared with the international advanced level. Currently, each of domestic aluminum factories has a DC consumption of around 13200˜3500 kWh/T.Al, some of which even approach 14000 kWh/T.Al. There is considerable potential to reduce the energy consumption. Especially in the case of current extremely severe economic conditions at home and aboard, it is much more imperative to save energy.

Recently, many patents take the way of adding bosses or choking blocks on cathode surfaces in order to achieve an object of improving flow velocity, lowering molten aluminum-electrolyte interface, decreasing polar distance, and saving energy and reducing energy consumption. However, most of those patents need to add an expensive investment. Some patents take the way of arranging high and low cathodes, but these arranging ways only simply arrange the high and low cathodes together without handling the shapes of cathodes, the energy saving effect is not notable in view of computer analysis result and practical production.

### SUMMARY OF THE INVENTION

An object of the present invention is to provide a method of configuring cathodes of an aluminum reduction cell, which takes the way of staggering high and low cathodes while chamfering at both ends on top surfaces of the high cathode or ramming chamfers thereon with inter-cathode paste. The method is capable of saving investment costs greatly, improving energy saving effect, achieving good stability of the aluminum reduction cell, so as to save energy and reduce energy consumption, thereby overcoming shortages in the prior art.

To achieve the above object, the present invention adopts the following technical solution comprising:

disposing cathode carbon blocks and cathode carbon rods at the bottom of the aluminum reduction cell, the cathode carbon blocks being formed by staggering high cathode blocks and low cathode blocks with different heights;

disposing bottom surfaces of the high cathode blocks and the low cathode blocks with the same height, the cathode steel rods in the cathode carbon blocks with different thicknesses being disposed at the same protruding position;

chamfering top surfaces of the high cathode blocks or ramming chamfers at both sides of top portions of the high cathode blocks by inter-cathode carbon paste, wherein the chamfers are bevels, round corners or other shaped chamfers so as to improve choking effect, and wherein a depth of the chamfers is not greater than a height difference between the high cathode blocks and the low cathode blocks;

the height difference between the high cathode blocks and the low cathode blocks being 50˜200 mm;

disposing grooves at an intermediate position in the length of the top portions of the high cathode blocks along short sides thereof, the grooves having a depth not greater than the height difference between the high cathode blocks and the low cathode blocks, and the grooves having a width of 100˜500 mm to facilitate the flow of the molten aluminum;

connecting the high cathode blocks and the low cathode blocks by ramming paste;

making the high cathode blocks and the low cathode blocks of such a material as anthracite carbon blocks, semi-graphitic carbon blocks or semi-graphitized or graphitized carbon blocks.

In comparison with the prior art, the present invention do not process the existing cathode carbon blocks to a great extent. It only staggers the cathode carbon blocks according to their different heights, and only partly chamfers and grooves the high cathode carbon blocks. The purpose of such a configuration is to overcome the vortex produced by the existing cathode carbon blocks and to lower the height of a molten aluminum-electrolyte interface. Through calculation analyses and onsite tests, the effect of choking resulted from chamfering the high cathode (or ramming chamfers with inter-cathode paste) is much better than the case without chamfering. The high and low cathode blocks are made of such a material as anthracite carbon blocks, semi-graphitic carbon blocks or semi-graphitized or graphitized carbon blocks. All of the above manufacturing materials are the materials used for manufacturing the existing cathode carbon blocks, thus no other special materials are needed, and thereby the present invention would not spend much money. Moreover, the present invention also has the advantages of less modification to the reduction cell, good energy saving effect, etc. and has excellent economic benefits, popularization values and use values.

### BRIEF DESCRIPTION OF THE DRAWINGS

FIG. 1 is a schematic view of the configuration of the present invention;

FIG. 2 is a Y-direction view of FIG. 1;

FIG. 3 is an X-direction view of FIG. 1;

FIG. 4 is a schematic view of high cathode blocks 1 with arc chamfers of the present invention;

FIG. 5 is a schematic view of ramming bevel chamfers by means of inter-carbon paste of the present invention;

FIG. 6 is a schematic view of chamfering both sides of top portions of the high cathode blocks in combination with means of ramming with inter-carbon paste of the present invention.

### DETAILED DESCRIPTION OF THE INVENTION

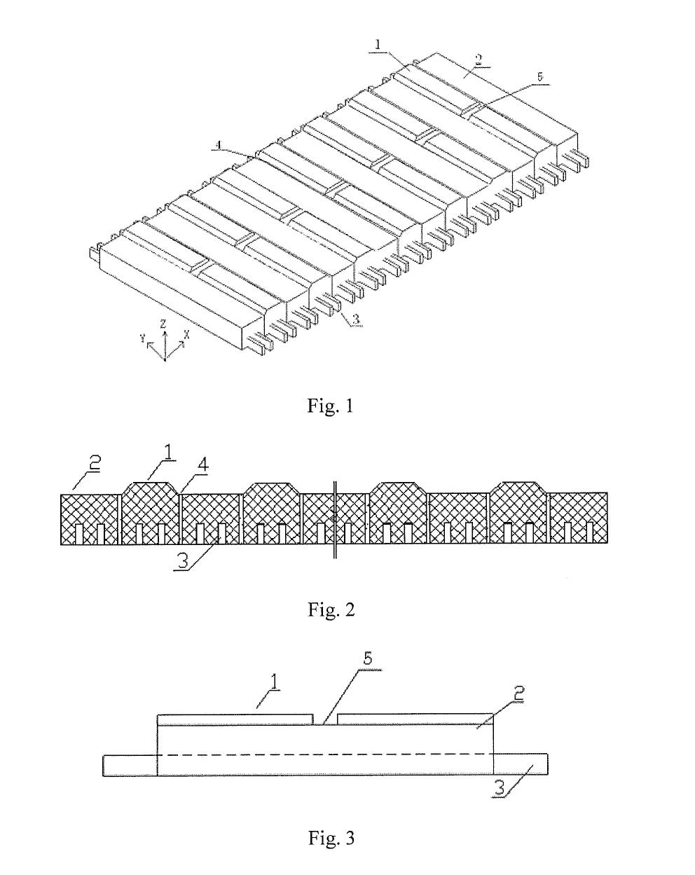

Embodiment 1: as shown in FIG. 1, cathode carbon blocks comprise high cathode blocks 1 and low cathode blocks 2. The cathode carbon blocks are disposed at the bottom of an aluminum reduction cell. Cathode steel rods 3 are disposed at bottom surfaces of the cathode carbon blocks. The cathode of the aluminum reduction cell is formed by staggering the high cathode blocks 1 and the low cathode blocks 2, wherein the high cathode blocks 1 and the low cathode blocks 2 are connected by ramming paste 4. The bottom surfaces of the high cathode blocks 1 and the low cathode blocks 2 are at the same elevation, wherein protruding positions of the cathode steel rods 3 in the cathode carbon blocks with different thicknesses are at the same elevation (FIG. 1). The side views of such an aluminum reduction cell with staggered arrangement are shown in FIGS. 2 and 3. The high cathode blocks 1 and the low cathode blocks 2 herein are made of such a material as anthracite carbon blocks, semi-graphitic carbon blocks or semi-graphitized or graphitized carbon blocks. All of the above manufacturing materials are the materials used for manufacturing the existing cathode carbon blocks, thus no other special materials are needed, and thereby no excessive costs would be incurred. Considering the choking effect and the manufacturing difficulty, a height difference between the high cathode blocks 1 and the low cathode blocks 2 is required to be 50˜150 mm; rectangular grooves 5 with a width of 100˜500 mm are transversely disposed at an intermediate position in the length direction of the high cathode blocks, wherein the depth of each of the grooves is not greater than the height difference between the high and low cathode blocks. The grooves are disposed to ensure normal flow of molten aluminum during production. To achieve the object of ideally destructing the flow field of molten aluminum and increasing the stability of the aluminum reduction cell so as to save electric energy, it is required to chamfer both sides of the top portion of each of the high cathode block. These chamfers could be round corners (FIG. 3). It should be noted that the aforementioned figures only show some of the manners and methods of forming chamfers at both sides of each of the high cathodes higher than each of the low cathodes, and the present invention is not limited to these manners of forming chamfers only.

Embodiment 2: as shown in FIG. 1, cathode carbon blocks comprise high cathode blocks 1 and low cathode blocks 2. The cathode carbon blocks are disposed at the bottom of an aluminum reduction cell. Cathode steel rods 3 are disposed at the bottom surfaces of the cathode carbon blocks. The cathode of the aluminum reduction cell is formed by staggering the high cathode blocks 1 and the low cathode blocks 2, wherein the high cathode blocks 1 and the low cathode blocks 2 are connected by ramming paste 4. The bottom surfaces of the high cathode blocks 1 and the low cathode blocks 2 are at the same elevation, wherein protruding positions of the cathode steel rods 3 in the cathode carbon blocks with different thicknesses are at the same elevation (FIG. 1). The side views of such an aluminum reduction cell with staggered arrangement are shown in FIGS. 2 and 3. The high cathode blocks 1 and the low cathode blocks 2 herein are made of such a material as anthracite carbon blocks, semi-graphitic carbon blocks or semi-graphitized or graphitized carbon blocks. All of the above manufacturing materials are the materials used for manufacturing the existing cathode carbon blocks, thus no other special materials are needed, and thereby no excessive costs would be incurred. Considering the choking effect and the manufacturing difficulty, a height difference between the high cathode blocks 1 and the low cathode blocks 2 is required to be 50˜150 mm; rectangular grooves 5 with a width of 100˜500 mm are transversely disposed at an intermediate position in the length direction of the high cathode blocks, wherein the depth of each of the grooves is not greater than the height difference between the high and low cathode blocks. The grooves are disposed to ensure normal flow of molten aluminum during production. To achieve the object of ideally destructing the flow field of molten aluminum and increasing the stability of the aluminum reduction cell so as to save electric energy, it is required to chamfer both sides of the top portion of each of the high cathode blocks. These chamfers could be bevels (FIG. 2). It should be noted that the aforementioned figures only show some of the manners and methods of forming chamfers at both sides of each of the high cathodes above each of the low cathodes, and the present invention is not limited to these manners of forming chamfers only.

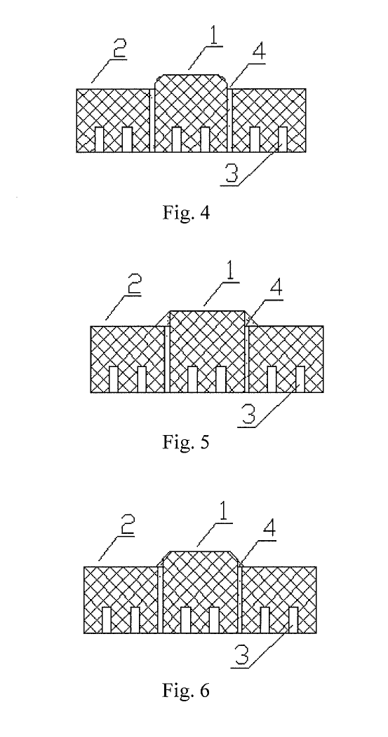

Embodiment 3: as shown in FIG. 1, cathode carbon blocks comprise high cathode blocks 1 and low cathode blocks 2. The cathode carbon blocks are disposed at the bottom of an aluminum reduction cell. Cathode steel rods 3 are disposed at the bottom surfaces of the cathode carbon blocks. The cathode of the aluminum reduction cell is formed by staggering the high cathode blocks 1 and the low cathode blocks 2, wherein the high cathode blocks 1 and the low cathode blocks 2 are connected by ramming paste 4. The bottom surfaces of the high cathode blocks 1 and the low cathode blocks 2 are at the same elevation, wherein protruding positions of the cathode steel rods 3 in the cathode carbon blocks with different thicknesses are at the same elevation (FIG. 1). The side views of such an aluminum reduction cell with staggered arrangement are shown in FIGS. 2 and 3. The high cathode blocks 1 and the low cathode blocks 2 herein are made of such a material as anthracite carbon blocks, semi-graphitic carbon blocks or semi-graphitized or graphitized carbon blocks. All of the above manufacturing materials are the materials used for manufacturing the existing cathode carbon blocks, thus no other special materials are needed, and thereby no excessive costs would be incurred. Considering the choking effect and the manufacturing difficulty, a height difference between the high cathode blocks 1 and the low cathode blocks 2 is required to be 50˜150 mm; rectangular grooves 5 with a width of 100˜500 mm are transversely disposed at an intermediate position in the length direction of the high cathode blocks, wherein the depth of each of the grooves is not greater than the height difference between the high and low cathode blocks. The grooves are disposed to ensure normal flow of molten aluminum during production. To achieve the object of ideally destructing the flow field of molten aluminum and increasing the stability of the aluminum reduction cell so as to save electric energy, it is required to chamfer both sides of the top portion of each of the high cathode blocks. These chamfers could be corners formed by ramming with inter-carbon paste (FIG. 4) or by combining cathode chamfering and inter-carbon paste ramming (FIG. 5). It should be noted that the aforementioned figures only show some of the manners and methods of forming chamfers at both sides of the high cathodes above the low cathodes, and the present invention is not limited to these manners of forming chamfers only.

1. A method of configuring cathodes of an aluminum reduction cell, comprising: disposing cathode carbon blocks and cathode steel rods (3) at the bottom of the aluminum reduction cell, characterized in that: the cathodes of the aluminum reduction cell are formed by staggering high cathode blocks (1) and low cathode blocks (2).

2. The method of configuring cathodes of an aluminum reduction cell according to claim 1, characterized in that: bottom surfaces of the high cathode blocks (1) and the low cathode blocks (2) are disposed on the same level, the cathode steel rods (3) being disposed at the same protruding position.

3. The method of configuring cathodes of an aluminum reduction cell according to claim 1, characterized in that: the height difference between the high cathode blocks (1) and the low cathode blocks (2) is 50˜200 mm.

4. The method of configuring cathodes of an aluminum reduction cell according to claim 1, characterized by: chamfering top surfaces of the high cathode blocks (1) or ramming chamfers at both sides of the top portion of each of the high cathode blocks (1) by inter-cathode carbon paste, or combining them.

5. The method of configuring cathodes of an aluminum reduction cell according to claim 4, characterized in that: the chamfers are bevels, round corners or other shaped chamfers.

6. The method of configuring cathodes of an aluminum reduction cell according to claim 1, characterized by: disposing grooves (5) at an intermediate position in the length of the top portions of the high cathode blocks (1) along short sides thereof.

7. The method of configuring cathodes of an aluminum reduction cell according to claim 1, characterized in that: the grooves (5) have a depth not greater than the height difference between the high cathode blocks and the low cathode blocks, and the grooves (5) have a width of 100˜500 mm.

8. The method of configuring cathodes of an aluminum reduction cell according to claim 1, characterized in that: the high cathode blocks (1) and the low cathode blocks (2) are connected by ramming paste (4).

9. The method of configuring cathodes of an aluminum reduction cell according to claim 1, characterized in that: the high cathode blocks (1) and the low cathode blocks (2) are made of such a material as anthracite carbon blocks, semi-graphitic carbon blocks or semi-graphitized or graphitized carbon blocks.
